(19) United States
(12) Patent Application Publication
(10) Pub. No.: US 2005/0227718 A1
(43) Pub. Date: Oct. 13, 2005

(54) Method and apparatus for call queuing in a cellular communication system

(76) Inventors: John M. Harris, Chicago, IL (US); Ronald T. Crocker, St. Charles, IL (US)

Correspondence Address: MOTOROLA, INC., 1303 EAST ALGONQUIN ROAD, IL01/3RD, SCHAUMBURG, IL, 60196, US

(21) Appl. No.: 10/820,542

(22) Filed: Apr. 8, 2004

(51) Int. Cl. H04Q 7/20

(52) U.S. Cl. 455/509; 455/517; 455/525

(57) ABSTRACT

A communication system is provided that transitions, or otherwise assures, that a queued origination or destination mobile station (MS) is in a Radio Environment Reporting (RER) mode. Based on Radio Environment Messages conveyed by the MS to a serving network when in an RER mode, the network is able to determine RF resource availability at an appropriate Base Station without having to first page the MS and is further able to consider whether the MS has roamed while queued. By not having to page the MS, delay is reduced relative to the prior art in setting up a call once it is determined that an RF resource may be assigned to the MS. Furthermore, less latency in involved for the network to place the MS into a Traffic state when transitioning from an RER mode than would be the case if the MS was dormant or in an Idle/Access state.

### FIELD OF THE INVENTION

The present invention relates generally to cellular communication systems, and, in particular, to call queuing in a cellular communication system.

### BACKGROUND OF THE INVENTION

In a 3GPP2 (Third Generation Partnership Project 2) communication system, when a mobile station (MS) attempts to originate a call, the MS initiates a transition to a Traffic state by conveying an Origination Message to a serving Base Transceiver Station (BS) via an associated Access Channel (ACH). The serving BTS is a BTS associated with a Pilot Channel having a highest signal strength as measured by the MS when in a non-Traffic state. Prior to transitioning to the Traffic state, in order to preserve power and to preserve Radio Frequency (RF) and infrastructure resources, the MS does not have a dedicated RF connection to the BTS or a dedicated connection between a Base Station (BS) that includes the BTS and a PCF. In response to receiving the Origination Message, the BS determines whether radio frequency (RF) resources, that is, RF traffic or voice channels, are immediately available for assignment to the MS. When no RF resources are immediately available, the BS aborts the call.

When an infrastructure attempts to originate a call with an MS that is not in a Traffic state, the infrastructure first pages the MS by conveying a General Page Message via a Paging Channel (PCH) in order to contact the MS. In response to the General Page Message, the MS initiates a transition to a Traffic state by conveying a Page Response Message to the infrastructure via a serving BTS. In response to receiving the Page Response Message, the infrastructure determines whether RF resources are immediately available for assignment to the MS. Again, when no RF resources are immediately available, the infrastructure aborts the call.

An exception to a termination of a call when no RF resources are available is the case of a priority access call, such as an emergency call. When a priority access call, that is, a PACA (Priority Access and Channel Availability) call, is originated by the MS and no traffic channels or voice channels are immediately available at the serving BTS, then the associated BS places the call into a queue and conveys a PACA message to the MS informing the MS of its position in the queue. PACA calls are specified in Section 2.6.2 of the TIA/EIA IS-5000.5-A standard and Section 2.2.2 of the 3GPP2 A.S0001-A standard, as commonly known in the art. In response to receiving the PACA message, the MS sets a PACA timer and transitions to an Idle state. The BS then periodically transmits PACA messages to the MS informing the MS of its position in the queue, and in response to receiving each PACA message, the MS resets its PACA timer.

When the PACA timer expires before the MS receives another PACA message, the MS determines that it is no longer queued. The user of the MS may then re-originate the call or give up. When the call rises to the top of the queue and an RF resource becomes available at the serving BTS prior to expiration of the PACA timer, the infrastructure conveys a PACA message to the MS instructing the MS to re-originate the call. In response to receiving the PACA message, the MS initiates a transition to a Traffic state by conveying a new Origination Message to the infrastructure. In response to receiving the new Origination Message, the infrastructure assigns an RF resource to the MS at its serving BTS.

One problem with a PACA call is the delay involved in setting up the call after the infrastructure determines that an RF resource is available at the serving BTS. That is, when the infrastructure determines that an RF resource is available, the infrastructure must convey a PACA message to the MS and wait for the MS to re-originate the call. Another problem with a PACA call is that it does not provide a queuing system for an MS that is a target, as opposed to an originator, of the call. For example, when the destination of a PACA call is another MS, RF resources may be available at the originating MS but not at the destination MS. In such an instance, the call is aborted due to a lack of RF resources at the destination end of the call.

Yet another problem with a PACA call is that it does not consider roaming. For example, the MS may have roamed to a second Base Transceiver Station (BTS) while in a queue associated with a first BTS. In one such situation, when resources free up at the first BTS, the MS may be instructed by the BS to re-originate the call when there are no RF resources available for assignment to the MS at the second BTS, resulting in a false start by the MS. In another such situation, the second BTS may have RF resources available for assignment to the MS but the infrastructure continues to wait for resources to free up at the first BTS before instructing the MS to originate a call.

Therefore, a need exists for a method and apparatus for queuing a call that does not require a queued MS to be paged and then wait for the MS to re-originate the call, that provides for queuing of a target MS, and that considers whether a queued MS has roamed in determining whether RF resources may be assigned to the MS.

### BRIEF DESCRIPTION OF THE DRAWINGS

FIG. 1 is a block diagram of a wireless communication system in accordance with an embodiment of the present invention.

FIG. 2 is a block diagram of a mobile station of FIG. 1 in accordance with an embodiment of the present invention.

FIG. 3 is a block diagram of a transceiver of FIG. 1 in accordance with an embodiment of the present invention.

FIG. 4 is a block diagram of a controller of FIG. 1 in accordance with an embodiment of the present invention

FIG. 5 is logic flow diagram of a method executed by the communication system of FIG. 1 in queuing a call for an originating mobile station in accordance with an embodiment of the present invention.

FIG. 6A is a logic flow diagram of a method executed by the communication system of FIG. 1 in queuing a call for a destination mobile station in accordance with an embodiment of the present invention.

FIG. 6B is a continuation of the logic flow diagram of FIG. 6A depicting a method executed by the communication system of FIG. 1 in queuing a call for a destination mobile station in accordance with an embodiment of the present invention.

FIG. 7 is a logic flow diagram of a method executed by the communication system of FIG. 1 in assigning a radio frequency resource to a queued mobile station in accordance with an embodiment of the present invention when the MS has roamed to a new service area.

### DETAILED DESCRIPTION OF THE INVENTION

To address the need for a method and an apparatus for queuing a call that does not require a queued mobile station (MS) to be paged and then wait for the MS to re-originate the call, that provides for queuing of a target MS, and that considers whether a queued MS has roamed in determining whether radio frequency (RF) resources may be assigned to the MS, a communication system is provided that transitions, or otherwise assures, that a queued origination or destination mobile station (MS) is in a Radio Environment Reporting (RER) mode. Based on Radio Environment Messages conveyed by the MS to a serving network when in an RER mode, the network is able to determine RF resource availability at an appropriate Base Station without having to first page the MS and is further able to consider whether the MS has roamed while queued. By not having to page the MS, delay is reduced relative to the prior art in setting up a call once it is determined that an RF resource may be assigned to the MS. Furthermore, less latency in involved for the network to place the MS into a Traffic state when transitioning from an RER mode than would be the case if the MS was dormant or in an Idle/Access state.

Generally, an embodiment of the present invention encompasses a method for queuing a mobile station in a wireless communication system. The method includes receiving a request from the mobile station to originate a call, determining whether the mobile station may be assigned a dedicated radio frequency (RF) resource in a service area of the mobile station, and in response to determining not to assign a dedicated RF resource to the mobile station, adding the call to a call queue. The method further includes subsequent to adding the call to the call queue, re-determining whether the mobile station may be assigned a dedicated RF resource in the service area and, in response to determining, subsequent to adding the call to the call queue, that the mobile station may be assigned a dedicated RF resource, conveying an assignment of a dedicate traffic channel to the mobile station without first requesting the mobile station to re-originate.

Another embodiment of the present invention encompasses a controller includes at least one memory device that maintains a call queue and a processor coupled to the at least one memory device. The processor receives a request from a mobile station to originate a call, determines whether the mobile station may be assigned a dedicated radio frequency (RF) resource in a service area of the mobile station, in response to determining not to assign a dedicated RF resource to the mobile station, adds the call to a call queue, subsequent to adding the call to the call queue, re-determines whether the mobile station may be assigned a dedicated RF resource in the service area, and in response to determining, subsequent to adding the call to the call queue, that the mobile station may be assigned a dedicated RF resource, conveys an assignment of a traffic channel to the mobile station without first requesting the mobile station to re-originate.

Yet another embodiment of the present invention encompasses a method for queuing a mobile station in a wireless communication system. The method includes receiving a call intended for the mobile station and determining whether the mobile station may be assigned a dedicated radio frequency (RF) resource in a service area of the mobile station. The method further includes, in response to determining not to assign a dedicated RF resource to the mobile station, adding the call to a call queue, subsequent to adding the call to the call queue, re-determining whether the mobile station may be assigned a dedicated RF resource in the service area, and in response to determining, subsequent to adding the call to the call queue, that the mobile station may be assigned a dedicated RF resource, conveying an assignment of a traffic channel to the mobile station without first paging the mobile station.

Still another embodiment of the present invention encompasses a controller that includes at least one memory device that maintains a call queue and a processor coupled to the at least one memory device. The processor receives a call intended for a mobile station serviced by the base station, determines whether the mobile station may be assigned a dedicated radio frequency (RF) resource in a service area of the mobile station, in response to determining not to assign a dedicated RF resource to the mobile station, adds the call to a call queue, subsequent to adding the call to the call queue, re-determines whether the mobile station may be assigned a dedicated RF resource in the service area, and in response to determining, subsequent to adding the call to the call queue, that the mobile station may be assigned a dedicated RF resource, conveys an assignment of a traffic channel to the mobile station without first paging the mobile station.

Yet another embodiment of the present invention encompasses a method for assigning a radio frequency (RF) resource to a queued mobile station. The method includes determining whether the mobile station may be assigned a dedicated radio frequency (RF) resource in a first service area of the mobile station and, in response to determining not to assign a dedicated RF resource to the mobile station, adding a call associated with the mobile station to a call queue. The method further includes receiving measurements of strengths of a plurality of pilot channels from the mobile station, based on the received pilot channel measurements, determining whether the mobile station has moved to a second service area, in response to determining that the mobile station has moved to the second service area, determining whether the mobile station may be assigned a dedicated RF resource in the second service area, and in response to determining that the mobile station may be assigned a dedicated RF resource in the second service area, assigning a dedicated RF resource to the mobile station in the second service area.

Still another embodiment of the present invention encompasses a Controller that includes at least one memory device that maintains a call queue and a processor coupled to the at least one memory device. The processor determines whether the mobile station may be assigned a dedicated radio frequency (RF) resource in a first service area, in response to determining not to assign a dedicated RF resource to the mobile station, adds a call associated with the mobile station to the call queue, receives measurements of strengths of a plurality of pilot channels from the mobile station, based on the received pilot channel measurements, determines whether the mobile station has moved to a second service area based on the received pilot channel measurements, in response to determining that the mobile station has moved to the second service area, determines whether the mobile station may be assigned a dedicated RF resource in the second service area, and in response to determining that the mobile station may be assigned a dedicated RF resource in the second service area, assigns a dedicated RF resource to the mobile station in the second service area.

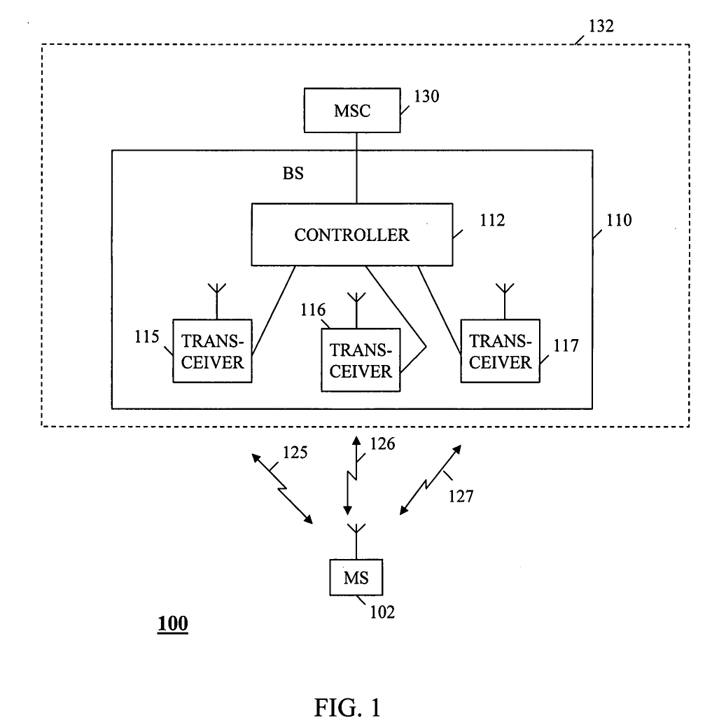

The present invention may be more fully described with reference to FIGS. 1-7. FIG. 1 is a block diagram of a wireless communication system 100 in accordance with an embodiment of the present invention. Communication system 100 includes a mobile station (MS) 102, such as but not limited to a cellular telephone, a radiotelephone, or a wireless modem coupled to data terminal equipment (DTE). Communication system 100 further includes a Base Station (BS) 110 in wireless communication with MS 102 via a serving transceiver, such as transceiver 116, of multiple transceivers 115-117 (three shown), such as multiple Base Transceiver Stations (BTSs), included in the BS. BS 110 further includes a Controller 112, such as a Base Station Controller (BSC) that includes a Selection and Distribution Unit (SDU) or a BSC coupled to an SDU, that is coupled to each transceiver of the multiple transceivers 115-117. Each transceiver 115-117 provides communications services to mobile stations (MS) located in a service area serviced by the transceiver. BS 110 is coupled to a Mobile Switching Center (MSC) 130, and together BS 110 and MSC 130 are collectively referred to herein as a network 132 of communication system 100

Each transceiver 115-117 is capable of providing communication services to MS 102 via a respective air interface 125-127. Each air interface 125-127 includes a forward link and a reverse link. The forward link of each air interface 125-127 includes a paging channel, a pilot channel, a forward common signaling channel, and multiple forward traffic channels. The reverse link of each air interface 125-127 includes an access channel and a multiple reverse traffic channels.

When MS 102 is in soft handoff with one or more of transceivers 115-117, controller 112 maintains the soft handoff. Control messages to and from MS 102 respectively originate and terminate at the controller 112. Controller 112 also selects the best data transmission received from MS 102 via the transceivers 115-117 in soft handoff with the MS for transmission to PCF 108 and distributes copies of data destined for MS 102 to all transceivers 115-117 in soft handoff with the MS. When in soft handoff with MS 102, each transceiver 115-117 transmits bearer data or voice to, and receives bearer data or voice from, the MS via a dedicated RF traffic or voice channel.

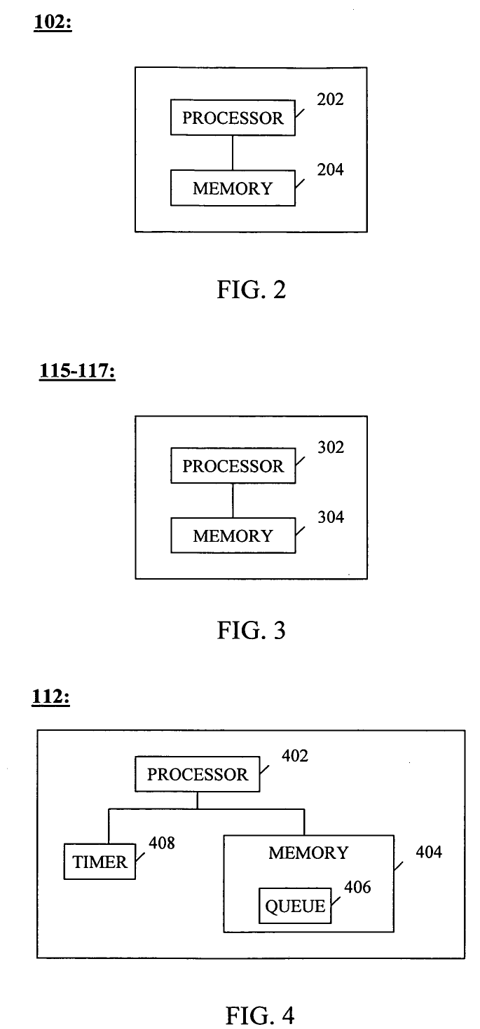

Referring now to FIGS. 2-4, each of MS 102, transceivers 115-117, and controller 112 includes a respective processor 202, 302, 402, such as one or more microprocessors, microcontrollers, digital signal processors (DSPs), combinations thereof or such other devices known to those having ordinary skill in the art. Each of MS 102, transceivers 115-117, and controller 112 further includes a respective at least one memory device 204, 304, 404 associated with processor, such as random access memory (RAM), dynamic random access memory (DRAM), and/or read only memory (ROM) or equivalents thereof, that store data and programs that may be executed by the processor. The at least one memory device 204, 404 of each of MS 102 and controller 112 further maintains a synchronized Active Set and Neighbor Set comprising pilot channels monitored by the MS and a synchronized state of the MS, such as whether the MS is in a Traffic state or in a Radio Environment Reporting (RER) mode as is described in greater detail below. When controller 112 comprises a BSC that includes an SDU, the SDU may be implemented in the respective processor 402 and the at least one memory device 404 of the BSC. When controller 112 comprises a BSC coupled to an SDU, then each of the BSC and the SDU comprises a processor associated with an at least one memory device and the functions of controller 112 may be performed by the processor of the BSC, by the processor of the SDU, or may be distributed between the processors of the BSC and the SDU. Unless otherwise specified herein, each function performed by MS 102, transceivers 115-117, and controller 112 is performed by the respective processor of such MS or network element.

Preferably, communication system 100 is a Code Division Multiple Access (CDMA) communication system and operates in accordance with the 3GPP2 (Third Generation Partnership Project 2) and TIA/EIA (Telecommunications Industry Association/Electronic Industries Association) IS-2000.5-A air interface standards and A.S0001-A network interoperability standards, which standards are hereby incorporated herein in their entirety. The standards specify wireless telecommunications system operating protocols, including radio system parameters and call processing procedures. In communication system 100, the communication channels of the forward links and reverse links of air interfaces 125-127, such as access channels, control channels, paging channels, and traffic channels, comprise orthogonal codes, such as Walsh Codes. However, those who are of ordinary skill in the art realize that communication system 100 may operate in accordance with any wireless telecommunication system, such as but not limited to a Global System for Mobile Communications (GSM) communication system, a Time Division Multiple Access (TDMA) communication system, a Frequency Division Multiple Access (FDMA) communication system, or an Orthogonal Frequency Division Multiple Access (OFDM) communication system.

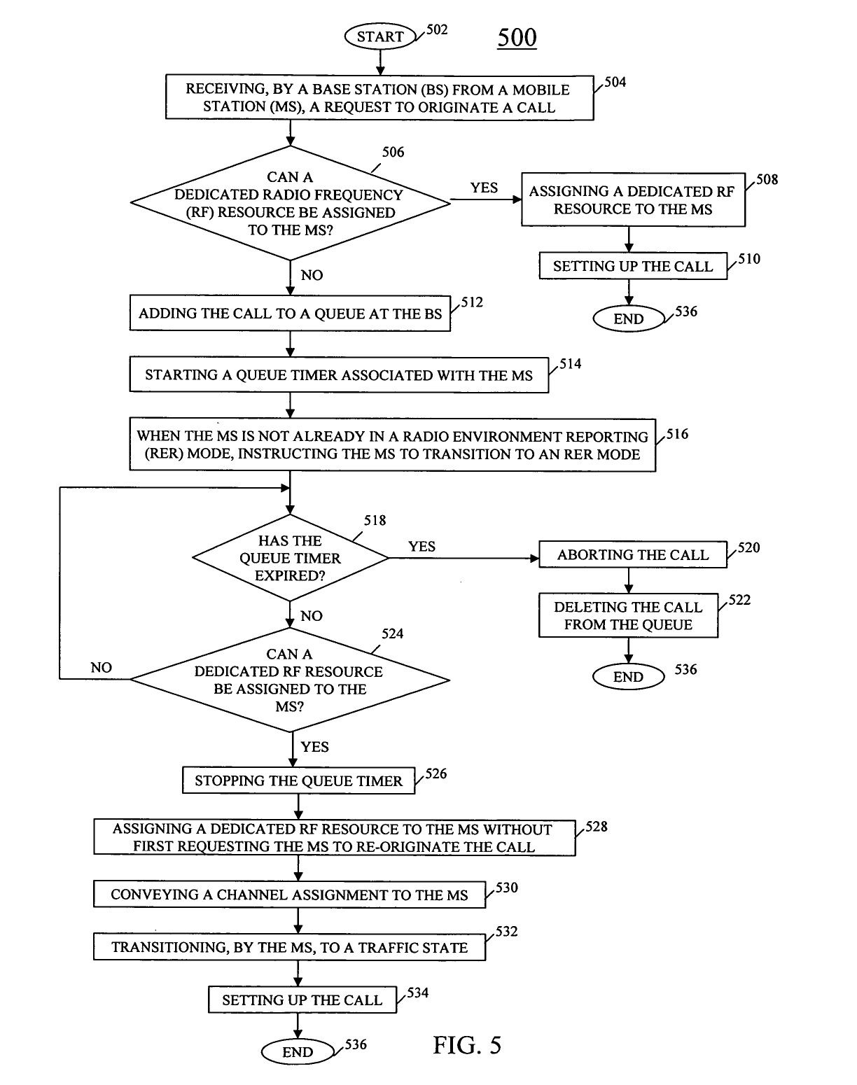

Referring now to FIG. 5, a logic flow diagram 500 is depicted of a method executed by communication system 100 in queuing a call originated by MS 102 in accordance with an embodiment of the present invention. Logic flow diagram 500 begins (502) when MS 102 conveys to BS 110, and in particular to a transceiver serving the MS, such as transceiver 116, and BS 110 receives (504) from the MS, a request to originate a call, such as a voice call, a packet data call, or a direct connect call. Preferably, MS 102 requests to originate the call by conveying an Origination Message to BS 110 via an access channel associated with serving transceiver 116. In response to receiving the request, BS 110, and in particular transceiver 116 or controller 112, makes (506) a preliminary radio frequency (RF) resource assignment decision, that is, determines whether a dedicated RF resource may be assigned to MS 102 in the forward and reverse links of air interface associated with the serving transceiver, that is, air interface 126.

In one embodiment of the present invention, BS 110 may make the preliminary RF resource assignment decision based on measured levels of signal quality in the service area of transceiver 116. That is, in one such embodiment of the present invention, each MS actively engaged in a communication with transceiver 116 may determine a signal quality metric, such as a Signal-to-Noise Ratio (SNR), a bit error rate (BER), or a frame error rate (FER), with respect to bearer traffic or voice received from transceiver 116 and report the determined signal quality metrics back to BS 110. Alternatively, transceiver 116 may determine a signal quality metric with respect to bearer traffic or voice received from each MS serviced by the transceiver. When a predetermined quantity of traffic channels have signal quality metrics that unacceptably compare to a signal quality metric threshold stored in the one or more memory devices of transceiver 116, then the BS determines that the service area is congested and that RF resources may not be assigned.

In another such embodiment of the present invention, BS 110 may make the preliminary RF resource assignment decision by determining a quantity of RF resources available at serving transceiver 116 and/or a cumulative power level of the assigned channels. BS 110 then compares the determined quantity of available RF resources and/or the cumulative power level to a corresponding RF resource threshold. The RF resource thresholds are set so that congestion of the service area served by transceiver 116 may be avoided. When the determined quantity of RF resources available at serving transceiver 116 and/or the cumulative power level of the assigned channels compares unacceptably with the corresponding threshold, then BS 110 determines that the service area is congested and that no additional RF resources may be assigned. For example, when the quantity of available RF resources is less than a threshold quantity of RF resources, or the cumulative power level is greater than a cumulative power level threshold, then BS 110 may determine that RF resources may not be assigned.

When BS 110 determines that a dedicated RF resource may be assigned to MS 102, the BS, and in particular transceiver 116 or controller 112, assigns (508) a dedicated RF resource to MS 102, for example, by conveying a Channel Assignment Message or an Extended Channel Assignment Message (ECAM), to the MS via a forward link signaling channel and the call is set up (510) in accordance with well-known call set up techniques. Logic flow 500 then ends (536).

When BS 110 determines that MS 102 may not be assigned a dedicated RF resource, then the BS, and in particular controller 112, adds (512) the call to a call queue 406 maintained in the at least one memory device 404 of the controller and starts (514) a queue timer 408 included in the controller, coupled to processor 402, and associated with the MS. When controller 112 comprises a BSC coupled to an SDU, then timer 408 may reside in either the SDU or BSC and be coupled to the respective processor of the SDU or BSC, and call queue 406 may be maintained in the at least one memory device of either the SDU or BSC. Timer 408 counts down a quantity of time that MS 102 is in queue 406. In various embodiments of the present invention, timer 408 may count down a predetermined period of time, may count down a period of time that is set by a user of MS 102, or may count down a period of time that corresponds to a Service Option (SO) associated with a the type of service being provided to the MS, such as data or voice service, or that is associated with a subscription package subscribed to by the user of the MS. For example, different subscription packages may permit the MS to remain in the queue for different quantities of time.

In other embodiments of the present invention, the step of adding (512) the call to a call queue may further be based on one or more of a handoff rate of MS 102, a mobility of the MS, a size of queue 406, and a Service Option (SO) of the call. For example, when the MS has a high handoff rate, such as an MS that has engaged in a number of idle handoffs that exceeds a threshold value over a predetermined time period, or is determined to be a fast moving MS, that is, an MS that is moving in excess of a threshold rate of speed, then BS 110 may add the call to queue 406 rather than abort the call since the MS is more likely to move soon to another sector where RF resources are likely to be available. When the MS has a low handoff rate, such as a rate less than the threshold value, or is a slow moving MS, then BS 110 may determine to abort the call since the MS is likely to linger longer in the queue. By way of another example, some Service Options, such as a data call and a file upload, are more delay tolerant than other Service Options, such as voice calls and Push-to-Talk (PTT) calls. In such an embodiment, BS 110 may determine whether to add the call to the queue based on the Service Option of the call, wherein more delay tolerant calls are queued and less delay tolerant calls are aborted. By way of yet another example, BS 110 may determine whether to add the call to the queue based on the queue size, determining to abort the call when the queue exceeds a predetermined size. In other embodiments of the invention, BS 110 may determine whether to add a call to the queue based on a combination of the above factors, for example, where a size of the queue may be used to determine the threshold value with respect to handoffs, the threshold value with respect to mobility rate, or the Service Options associated with a call that may be added to the queue.

In addition, when BS 110 determines that MS 102 may not be assigned a dedicated RF resource and MS 102 is not in a Radio Environment Reporting (RER) mode, the BS, and in particular controller 112, further instructs (516) MS 102 to transition into an RER mode, as described below in greater detail. By assuring that MS 102 is in an RER mode while the call is queued, controller 112 is able to receive reports on the wireless environment from the MS that allow the controller to determine a location of the MS and associated RF resource availability without having to first page the MS. In response to being instructed to transition to into the RER mode, MS 102 may notify a user of the MS that the call has been queued by playing a ringing tone to the user or displaying a message to the user informing that the call has been queued. The user of MS 102 may then terminate the queuing of the call at any time by opting to leave a voice message for the target of the call, for example, by depressing a key or touching a softkey on an interface of MS 104 that instructs the MS to convey a request to the infrastructure to be connected to the voice mail of a target communication device, or by simply hanging up.

The RER mode is described in IS-2000-D. In the RER mode, MS 102 does not have a dedicated RF connection. However, when in the RER mode, MS 102 periodically measures strengths of Pilot Channels (hereafter also referred to as pilots) associated with a Radio Environment Report List, which List includes pilots that are associated with an Active Set or a Neighbor Set of the MS. In response to changes in measured signal strengths, MS 102 conveys the measured signal strengths to BS 110 via a Radio Environment Message (REM). BS 110, and in particular controller 112, then uses the pilot strength information from the received signal strength measurement reports to determine service areas, and associated transceivers, in which to assign dedicated RF resources to the MS.

By transitioning MS 102 to an RER mode, network 132 is updated via REMs and there is typically less latency required for the network to place MS 102 into the traffic channel state than would be the case if the MS was dormant or in an Idle/Access state. In addition, by transitioning MS 102 to an RER mode, the call uses less RF resources that it would if it was simply placed in the Traffic state.

One example of a state of an MS when in the RER mode is a Control Hold state. The Control Hold state is well-known and is described in IS-5000-D. In such a state, MS 102 is not able to immediately began full-duplex communication with the network over a dedicated RF channel or resource, but rather must suffer some amount of latency. However, when in such state, MS 102 uses significantly less resources than would be the case if it was simply placed in the Traffic state After controller 112 starts timer 408 and instructs MS 102 to transition to an RER mode, BS 110, and in particular controller 112, periodically revisits the preliminary radio frequency (RF) resource assignment decision by re-determining (524), as described in detail above, whether an RF resource currently may be assigned to MS 102 in the forward and reverse links of air interface 126 based on the last REM received from the MS (which, if the MS was in an RER mode prior to the call being queued, may be an REM received prior to the queuing). When queue timer 408 expires (518) prior to the call originated by MS 102 rising to the top of call queue 406 and prior to controller 112 determining that a dedicated RF resource at BS 110 may be assigned to the MS, then BS 110, and in particular controller 112, aborts (520) the call and deletes (522) the call from queue 406. Logic flow 500 then ends (536).

When, prior to expiration (518) of queue timer 408, MS 102 rises to the top of call queue 406 and controller 112 determines (524) that a dedicated RF resource at BS 110, for example, at one of transceivers 115-117, may be assigned to the MS, then controller 112 stops (526) the timer, assigns (528) a dedicated RF resource to MS 102, and conveys (530) the channel assignment to the MS, for example, by conveying a Channel Assignment Message or an Enhanced Channel Assignment Message (ECAM) via a forward link signaling channel associated with transceiver with the strongest pilot, without first paging the MS to determine its location and requesting that the MS re-originate the call. That is, controller 112 is aware of a location of MS 102, that is, a transceiver associated with a strongest pilot as measured by the MS, based on the pilot strength measurement reports conveyed by the MS to the BS. When controller 112 determines that a dedicated RF resource may be assigned to MS 102, the controller assigns a dedicated RF resource to the MS 102 and informs the MS of the assigned RF resource by communicating with the MS via the transceiver associated with the strongest pilot. In response to receiving the channel assignment, the MS transitions (532) to a Traffic state and the call is set up (534) in accordance with well-known call set up techniques. Logic flow 500 then ends (536).

By transitioning MS 102 to, or otherwise assuring that an MS 102 is in, an RER mode when the call is queued, network 132 is updated on the MS's wireless environment via REMs. As a result, network 132 is able to determine a transceiver at which to assign an RF resource to the MS without having to first page the MS and determine its location while the call is in the queue and request that the MS re-originate the call. Thus delay is reduced relative to the prior art in setting up a call once it is determined that an RF resource may be assigned to the MS. Furthermore, there is typically less latency involved when the network places MS 102 into the Traffic state when transitioning from an RER mode than would be the case if the MS was dormant or in an Idle/Access state.

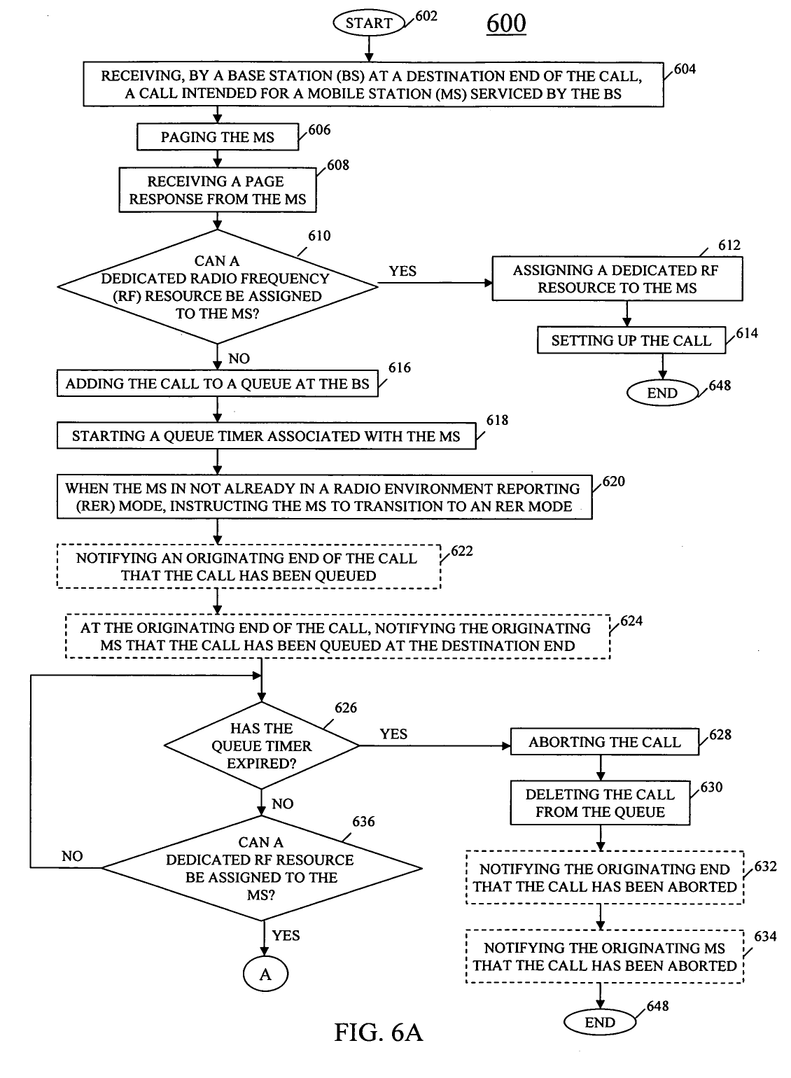

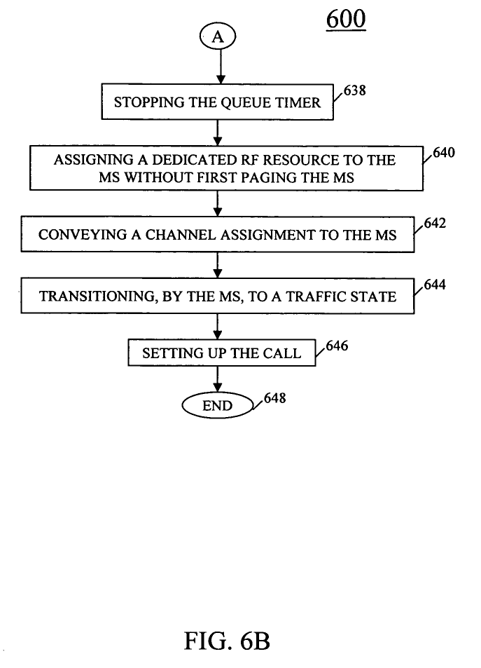

FIGS. 6A and 6B depict a logic flow diagram 600 illustrating a method executed by communication system 100 in queuing a call intended for MS 102 when MS 102 is a target MS in accordance with another embodiment of the present invention. Logic flow diagram 600 begins (602) when BS 110 receives (604) a call intended for MS 102. In response to receiving the call, BS 110, and in particular controller 112, notifies (606) the MS of the call by paging the MS. In response to receiving the page, MS 102 conveys to BS 110, in particular controller 112, and the BS receives (608) from the MS, a page response.

In response to receiving the page response, controller 112 makes (610) a preliminary radio frequency (RF) resource assignment decision as is described above in greater detail, that is, determines whether an RF resource may be assigned to MS 102 in the forward and reverse links of an air interface associated with a transceiver serving the MS, that is, transceiver 116 and associated air interface 126. When controller 112 determines that an RF resource may be assigned to MS 102, the controller assigns (612) a dedicated RF resource to MS 102, for example, by conveying a Channel Assignment Message or an Extended Channel Assignment Message (ECAM), to the MS via a forward link signaling channel. The call is then set up (614) in accordance with well-known call set up techniques and logic flow 600 ends (648).

When BS 110 determines that MS 102 may not be assigned an RF resource, then the BS, and in particular controller 112, adds (616) the call to a call queue 406 maintained in the one or more memory devices of the controller and starts (618) a queue timer 408 included in the controller and associated with the MS. Again, similar to step 512 above, in other embodiments of the present invention the step of adding (616) the call to a call queue may further be based on one or more of a handoff rate, such as an idle handoff rate, of MS 102, a mobility of the MS, a size of queue 406, and a Service Option (SO) of the call. BS 110 also instructs (620) MS 102 to transition to an RER mode when MS 102 is not already in a Radio Environment Reporting (RER) mode.

BS 110, in particular controller 112, optionally also may notify (622) the originating end, such as an MSC or a BS associated with an originating MS, for example, MSC 130 and BS 110 when MS 102 is the originating MS rather than the target MS, that the call has been queued. Such a notification can occur any time after the call is queued and need not immediately occur at the time that the call is queued. When the originating end is notified of the queuing of the call at the destination end, then in response to being so notified, the MSC or BS associated with an originating MS, that is, the originating MSC or BS, may then notify (624) the originating MS that the call has been queued at the destination end of the call. For example, the originating MSC or BS may notify the originating MS that the target MS is being located, for example by convey to the originating MS, or instruct the originating MS to display, a text message informing that the target MS is being located. By way of another example, the originating MSC or BS may convey to the originating MS, or instruct the originating MS to play, a ringing tone such as the typical ringing tone played when a call is being set up.

After controller 112 starts timer 408, controller 112 periodically revisits the preliminary RF resource assignment decision by re-determining (636) whether an RF resource currently may be assigned to MS 102 at BS 110, for example, at one of transceivers 115-117, based on the last REM received from the MS (which, if the MS was in an RER mode prior to the call being queued, may be an REM received prior to the queuing). When queue timer 408 expires (626) prior to the call intended for MS 102 rising to the top of call queue 406 and prior to controller 112 determining that a dedicated RF resource at BS 110 may be assigned to the MS, then BS 110, and in particular controller 112, aborts (628) the call and deletes (630) the call from queue 406. Controller 112 optionally may notify (632) the originating end, such as an MSC or a BS associated with an originating MS, that the call has been aborted. The originating end, for example, MSC 130 and BS 110 when MS 102 is the originating MS rather than the target MS, then may notify (634) the originating MS that the call has been aborted, for example, by conveying to the originating MS, or instruct the originating MS to play, a busy tone. Logic flow 600 then ends (648).

When, prior to expiration (626) of queue timer 408, MS 102 rises to the top of call queue 406 and controller 112 determines (636) that a dedicated RF resource at BS 110 may be assigned to the MS, then controller 112 stops (638) the timer, assigns (640) a dedicated RF resource to MS 102, and conveys (642) the channel assignment to the MS, for example, by conveying a Channel Assignment Message or an ECAM via a forward link signaling channel associated with a transceiver with the strongest pilot, without first paging the MS. That is, controller 112 is aware of a location of MS 102, that is, a transceiver associated with a strongest pilot as measured by the MS, based on the pilot strength measurement reports conveyed the MS to BS 110. When controller 112 determines that a dedicated RF resource may be assigned to MS 102, the controller assigns a dedicated RF resource to the MS 102 and informs the MS of the assigned RF resource by communicating with the MS via the transceiver associated with the strongest pilot. In response to receiving the channel assignment, the MS transitions (644) to a Traffic state and the call is set up (646) in accordance with well-known call set up techniques. Logic flow 600 then ends (648).

Thus communication system 100 provides for queuing of a destination MS as well as an originating MS. Furthermore, by transitioning a destination MS to, or otherwise assuring that the destination MS is in, an RER mode when the call is queued at the destination end of the call, network 132 is able to determine a transceiver at which to assign an RF resource to the MS without having to first page the MS and determine its location while the call is in the queue. And again, there is typically less latency involved when the network places MS 102 into the Traffic state when transitioning from an RER mode than would be the case if the MS was dormant or in an Idle/Access state.

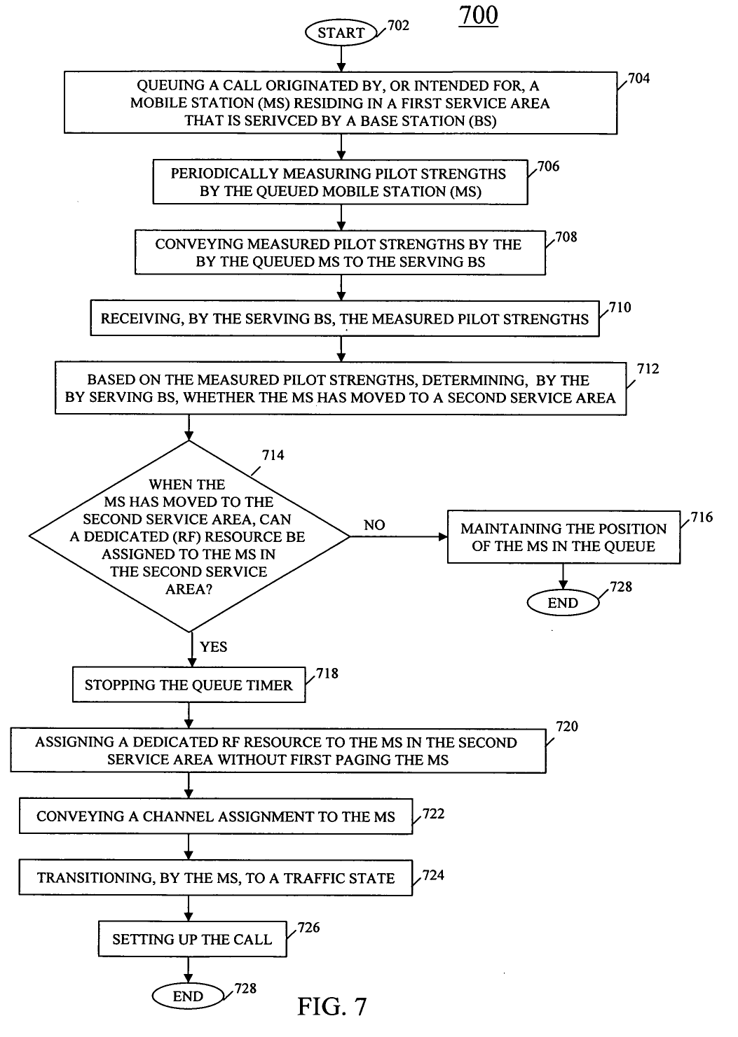

Communication system 100 further provides for a queued MS to be assigned an RF resource when an RF resource is available in a service area to which the MS has roamed. FIG. 7 is a logic flow diagram 700 of a method executed by communication system 100 in assigning an RF resource to queued MS in accordance with an embodiment of the present invention when the MS has roamed to a new service area. Logic flow diagram 700 begins (702) when a call originated by, or intended for, an MS, that is MS 102, residing in a first service area that is serviced by a first transceiver, that is transceiver 116, is queued (704), that is, is added to a call queue 406, in an associated BS 110.

As described in detail above, when the call is queued, MS 102 is in an RER mode and periodically measures (706) strengths of pilots associated with an Active Set or a Neighbor Set of the MS. When in the RER mode, in response to changes in measured signal strengths, MS 102 conveys (708) to BS 110, and in particular a controller serving the MS, that is, controller 112, and the controller receives (710) from the MS, the measured pilot strengths, preferably via an REM. Based on the pilot strength information included in the received signal strength measurement reports, BS 110, and in particular controller 112, determines (712) whether the MS has roamed to a second service area, such as a service area associated with transceiver 117. For example, BS 110 may determine that MS 110 has roamed to a second service area when there is a change in the highest strength pilot. When BS 110 determines that MS 102 has roamed to a second service area, that is, a new service area associated with the new highest strength pilot, the BS, and in particular controller 112, further makes (714) a preliminary radio frequency (RF) resource assignment decision with respect to the second service area. That is, BS 110 determines whether an RF resource may be assigned to MS 102 in the forward and reverse links of air interface associated with the transceiver serving the second service area, as is described in detail above.

When BS 110 determines that MS 102 may not be assigned an RF resource in the second service area, the BS maintains (716) the current position of the MS in queue 406. Logic flow 700 then ends (728). When BS 110 determines that MS 102 may be assigned an RF resource in the second service area, then controller 112 stops (718) a timer 408 associated with the MS, assigns (720) a dedicated RF resource in the second service area to the MS, and conveys (722) a channel assignment to the MS, for example, by conveying a Channel Assignment Message or an ECAM via a forward link signaling channel associated with the second service area and corresponding transceiver, that is, transceiver 117, without first paging the MS. Again, controller 112 is aware of a location of MS 102, that is, a transceiver associated with a strongest pilot as measured by the MS, based on the pilot strength measurement reports conveyed by the MS to BS 110. When controller 112 determines that a dedicated RF resource may be assigned to MS 102, the controller assigns a dedicated RF resource to the MS 102 at the transceiver associated with the strongest pilot and informs the MS of the assigned RF resource by communicating with the MS via the transceiver associated with the strongest pilot. In response to receiving the channel assignment, the MS transitions (724) to a Traffic state and the call is set up (726) in accordance with well-known call set up techniques. Logic flow 700 then ends (728).

By transitioning a queued origination or destination MS to an RER mode and receiving REM's from the MS while the call is queued, communication system 100 is able consider whether an MS has roamed in assigning an RF resource to the MS without having to first page the MS and determine its location while the call is in the queue. In addition, network 132 is able to determine RF resource availability in an appropriate service area, rather than determining RF resource availability at a first service area when the MS has roamed to a second service area. And again, by placing a queued MS in the RER mode and by receiving REM's from the MS, delay is reduced relative to the prior art in setting up a call once it is determined that an RF resource may be assigned to the MS and less latency is involved when the network places MS 102 into the Traffic state when transitioning from an RER mode than would be the case if the MS was dormant or in an Idle/Access state.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

1. A method for queuing a mobile station in a wireless communication system comprising:
receiving a request from the mobile station to originate a call;
determining whether the mobile station may be assigned a dedicated radio frequency (RF) resource in a service area of the mobile station;
in response to determining not to assign a dedicated RF resource to the mobile station, adding the call to a call queue;
subsequent to adding the call to the call queue, re-determining whether the mobile station may be assigned a dedicated RF resource in the service area; and
in response to determining, subsequent to adding the call to the call queue, that the mobile station may be assigned a dedicated RF resource, conveying an assignment of a dedicate traffic channel to the mobile station without first requesting the mobile station to re-originate.

2. The method of claim 1, wherein re-determining whether the mobile station may be assigned a dedicated radio frequency (RF) resource comprises determining whether the mobile station may be assigned a dedicated RF in a service area of the mobile station based on signal strengths reported by the mobile station.

3. The method of claim 1, wherein re-determining whether the mobile station may be assigned a dedicated radio frequency (RF) resource comprises determining whether the mobile station may be assigned a dedicated RF in a service area of the mobile station based on a last Radio Environment Message received from the mobile station.

4. The method of claim 1, further comprising:
starting a timer;
when the timer expires prior to determining that the mobile station may be assigned a dedicated RF resource in the service area, aborting the call and deleting the call from the queue; and
wherein conveying an assignment of a dedicated radio frequency (RF) resource comprises conveying an assignment of a traffic channel to the mobile station in response to determining, subsequent to adding the call to a call queue and prior to the expiration of the timer, that the mobile station may be assigned a dedicated RF resource in the service area.

5. The method of claim 1, further comprising, in response to determining not to assign a dedicated RF resource to the mobile station, instructing the mobile station to transition to a Radio Environment Reporting mode.

6. The method of claim 5, wherein the Radio Environment Reporting mode comprises a Control Hold state.

7. The method of claim 5, further comprising, in response to determining, subsequent to adding the call to the call queue, that the mobile station may be assigned a dedicated RF resource, instructing the mobile station to transition to a Traffic state.

8. A Controller comprising
at least one memory device that maintains a call queue; and
a processor coupled to the at least one memory device that receives a request from the mobile station to originate a call, determines whether the mobile station may be assigned a dedicated radio frequency (RF) resource in a service area of the mobile station, in response to determining not to assign a dedicated RF resource to the mobile station, adds the call to a call queue, subsequent to adding the call to the call queue, re-determines whether the mobile station may be assigned a dedicated RF resource in the service area, and in response to determining, subsequent to adding the call to the call queue, that the mobile station may be assigned a dedicated RF resource, conveys an assignment of a traffic channel to the mobile station without first requesting the mobile station to re-originate.

9. The Controller of claim 8, further comprising a timer coupled to the processor, wherein the processor, subsequent to adding the call to a call queue, starts the timer, wherein, when the timer expires prior to determining that the mobile station may be assigned a dedicated radio frequency (RF) resource in the service area, the processor aborts the call and deletes the call from the queue, and wherein the processor conveys an assignment of a dedicated RF resource by conveying an assignment of a dedicated RF resource to the mobile station in response to determining, subsequent adding the call to a call queue and prior to the expiration of the timer, that the mobile station may be assigned a dedicated RF resource in the service area.

10. A method for queuing a mobile station in a wireless communication system comprising:
receiving a call intended for the mobile station;
determining whether the mobile station may be assigned a dedicated radio frequency (RF) resource in a service area of the mobile station;
in response to determining not to assign a dedicated RF resource to the mobile station, adding the call to a call queue;
subsequent to adding the call to the call queue, re-determining whether the mobile station may be assigned a dedicated RF resource in the service area; and
in response to determining, subsequent to adding the call to the call queue, that the mobile station may be assigned a dedicated RF resource, conveying an assignment of a traffic channel to the mobile station without first paging the mobile station.

11. The method of claim 10, wherein re-determining whether the mobile station may be assigned a dedicated radio frequency (RF) resource comprises determining whether the mobile station may be assigned a dedicated RF in a service area of the mobile station based on signal strengths reported by the mobile station.

12. The method of claim 10, wherein re-determining whether the mobile station may be assigned a dedicated radio frequency (RF) resource comprises determining whether the mobile station may be assigned a dedicated RF in a service area of the mobile station based on a last Radio Environment Message received from the mobile station.

13. The method of claim 10, wherein determining whether the mobile station may be assigned a dedicated radio frequency (RF) resource comprises:
paging the mobile station;
in response to paging, receiving a page response from the mobile station; and
in response to receiving the page response, determining whether the mobile station may be assigned a dedicated RF resource in a service area of the mobile station.

14. The method of claim 10, further comprising:
starting a timer;
when the timer expires prior to determining that the mobile station may be assigned a dedicated RF resource in the service area, aborting the call and deleting the call from the queue; and
wherein conveying an assignment of a dedicated radio frequency (RF) resource comprises conveying an assignment of a dedicated RF resource to the mobile station in response to determining, subsequent adding the call to a call queue and prior to the expiration of the timer, that the mobile station may be assigned a dedicated RF resource in the service area.

15. The method of claim 14, further comprising, when the timer expires prior to determining that the mobile station may be assigned a dedicated radio frequency resource in the service area, deleting the call from the queue.

16. The method of claim 14, further comprising, when the timer expires prior to determining that the mobile station may be assigned a dedicated radio frequency resource in the service area, notifying an originating end of the call that the call has been aborted.

17. The method of claim 10, further comprising, in response to determining not to assign a dedicated RF resource to the mobile station, instructing the mobile station to transition to a Radio Environment Reporting mode.

18. The method of claim 17, wherein the Radio Environment Reporting mode comprises a Control Hold state.

19. A Controller comprising:
at least one memory device that maintains a call queue; and
a processor coupled to the at least one memory device that receives a call intended for a mobile station serviced by the base station, determines whether the mobile station may be assigned a dedicated radio frequency (RF) resource in a service area of the mobile station, in response to determining not to assign a dedicated RF resource to the mobile station, adds the call to a call queue, subsequent to adding the call to the call queue, re-determines whether the mobile station may be assigned a dedicated RF resource in the service area, and in response to determining, subsequent to adding the call to the call queue, that the mobile station may be assigned a dedicated RF resource, conveys an assignment of a traffic channel to the mobile station without first paging the mobile station.

20. The Controller of claim 19, further comprising a timer coupled to the processor, wherein the processor, subsequent to adding the call to a call queue, starts the timer, wherein, when the timer expires prior to determining that the mobile station may be assigned a dedicated radio frequency (RF) resource in the service area, the processor aborts the call and deletes the call from the queue, and wherein the processor conveys an assignment of a dedicated RF resource by conveying an assignment of a dedicated RF resource to the mobile station in response to determining, subsequent adding the call to a call queue and prior to the expiration of the timer, that the mobile station may be assigned a dedicated RF resource in the service area.

21. A method for assigning a radio frequency (RF) resource to a queued mobile station comprising:
determining whether the mobile station may be assigned a dedicated radio frequency (RF) resource in a first service area of the mobile station;
in response to determining not to assign a dedicated RF resource to the mobile station, adding a call associated with the mobile station to a call queue;
receiving measurements of strengths of a plurality of pilot channels from the mobile station;
based on the received pilot channel measurements, determining whether the mobile station has moved to a second service area;
in response to determining that the mobile station has moved to the second service area, determining whether the mobile station may be assigned a dedicated RF resource in the second service area; and
in response to determining that the mobile station may be assigned a dedicated RF resource in the second service area, assigning a dedicated RF resource to the mobile station in the second service area.

22. The method of claim 21, wherein assigning a dedicated RF resource to the mobile station in the second service area comprises in response to determining that the mobile station may be assigned a dedicated RF resource in the second service area, assigning a dedicated RF resource to the mobile station in the second service area without first paging the mobile station.

23. A Controller comprising:
at least one memory device that maintains a call queue; and
a processor coupled to the at least one memory device that determines whether the mobile station may be assigned a dedicated radio frequency (RF) resource in a first service area, in response to determining not to assign a dedicated RF resource to the mobile station, adds a call associated with the mobile station to the call queue, receives measurements of strengths of a plurality of pilot channels from the mobile station, based on the received pilot channel measurements, determines whether the mobile station has moved to a second service area based on the received pilot channel measurements, in response to determining that the mobile station has moved to the second service area, determines whether the mobile station may be assigned a dedicated RF resource in the second service area, and in response to determining that the mobile station may be assigned a dedicated RF resource in the second service area, assigns a dedicated RF resource to the mobile station in the second service area.

24. The Controller of claim 23, wherein the processor assigns a dedicated RF resource to the mobile station in the second service area without first paging the mobile station.
